(19) United States
(12) Patent Application Publication
(10) Pub. No.: US 2021/0359533 A1
(43) Pub. Date: Nov. 18, 2021

(54) CONTROLLER FOR POWER SUPPLY CIRCUIT, STORAGE MEDIUM STORING PROGRAM THAT CONTROLS POWER SUPPLY CIRCUIT, AND CONTROL METHOD FOR POWER SUPPLY CIRCUIT

(71) Applicant: TOYOTA JIDOSHA KABUSHIKI KAISHA, Toyota-shi (JP)

(72) Inventor: Takahiro HATANO, Nagakute-shi (JP)

(73) Assignee: TOYOTA JIDOSHA KABUSHIKI KAISHA, Toyota-shi (JP)

(21) Appl. No.: 17/229,420

(22) Filed: Apr. 13, 2021

(30) Foreign Application Priority Data
May 13, 2020 (JP) 2020-084534

(51) Int. Cl. H02J 7/00; H02M 3/158

(52) U.S. Cl. CPC H02J 7/00712; H02J 7/0047; H02P 27/06; H02J 2207/20; H02M 3/1582

(57) ABSTRACT

A controller includes a voltage increasing unit and a pre-charge controlling unit. The voltage increasing unit stops a voltage increasing operation of a converter based on a converter controlling signal delivered from the pre-charge controlling unit. After the charged voltage of the capacitor shifts from an increase to a decrease in response to stopping of the voltage increasing operation of the converter, the pre-charge controlling unit refrains from switching a relay when a charged voltage of a capacitor is out of a target voltage range, and establishes an electrical connection of the relay when the charged voltage of the capacitor becomes a value within a target voltage range.

### BACKGROUND

### 1. Field

The present disclosure relates to a controller for a power supply circuit, a storage medium storing a program that controls a power supply circuit, and a control method for a power supply circuit.

### 2. Description of Related Art

Japanese Laid-Open Patent Publication No. 2008-289326 discloses an electric power system that includes a first battery, which includes a rechargeable battery. The first battery is connected to an electrical load via relays, which selectively establish and break an electrical connection. A capacitor is connected across the relays and the electrical load. The electric power system also includes a second battery having a rated voltage lower than that of the first battery. The second battery is connected to a converter. The converter is connected to the relays and the electrical load to increase the output voltage of the second battery and to deliver the output voltage to the electrical load.

Before starting a supply of power from the first battery to the electrical load, a controller of the electric power system performs a pre-charge process with the electrical connection being broken between the first battery and the electrical load. When performing the pre-charge process, the controller drives the converter to perform a voltage increasing operation until the charged voltage of the capacitor, which increases together with the output voltage of the converter, reaches a value substantially equal to a target voltage, which is specified as the output voltage of the first battery. When the converter ends the voltage increasing operation, the controller switches the relays on.

In some arts, a controller such as the one disclosed in the above-described publication separately includes a high-order circuit, which commands a voltage increasing operation by a converter, and a low-order circuit, in which the converter actually performs the voltage increasing operation. In some cases, the output voltage of the converter is actually measured, separately from the detection of the charged voltage of the capacitor. Further, in some cases, while the charged voltage of the capacitor is acquired in the high-order circuit, the output voltage of the converter is acquired in the low-order circuit, and the voltage increasing operation is performed until the output voltage reaches the target voltage.

An acquisition failure may occur in which the low-order circuit cannot acquire the output voltage of the converter. In this case, the low-order circuit cannot determine whether the output voltage of the converter has reached the target voltage. In other words, the low-order circuit cannot determine the point in time at which the voltage increasing operation of the converter should be stopped. To cope with such a situation, the high-order circuit may determine the completion of the voltage increasing operation of the converter based on the charged voltage of the capacitor, and output, to the low-order circuit, a stop signal for the voltage increasing operation. However, there is a certain delay from when the high-order circuit outputs a stop signal to when the low-order circuit receives that signal and actually stops the voltage increasing operation of the converter. The converter continues to increase the voltage during the delay. The output voltage of the converter thus may exceed the target voltage by a significant amount when the converter ends the voltage increase operation and the relays are switched on.

Transfer of a charged voltage between the high-order circuit and the low-order circuit takes time not only in a case in which the high-order circuit outputs a stop signal to the low-order circuit, but also, for example, in a case in which the high-order circuit outputs the charged voltage of the capacitor to the low-order circuit, so that the low-order circuit determines completion of the voltage increasing operation based on the charged voltage. Thus, the point in time at which the voltage increasing operation is determined to be completed is delayed with respect to the point in time at which the real-time charged voltage reaches the target voltage. Accordingly, the output voltage of the converter may exceed the target voltage by a significant amount at the point in time at which the relays are switched on, bringing about drawbacks similar to the ones described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller configured to control a power supply circuit is provided. The power supply circuit includes a first battery, a battery voltage sensor configured to detect an output voltage of the first battery, a relay that selectively establishes and breaks an electrical connection from the first battery to a load, a second battery having a rated voltage lower than a rated voltage of the first battery, a converter configured to increase an output voltage of the second battery and to output the increased output voltage to a section between the relay and the load, a converter voltage sensor configured to detect an output voltage of the converter, a capacitor that is located between the relay and the load and is connected to the relay, and a capacitor voltage sensor configured to detect a charged voltage of the capacitor. The controller is configured to execute a pre-charge process that performs, in a state in which the electrical connection between the first battery and the load is broken by the relay, a voltage increasing operation of the converter until the output voltage of the converter becomes a value within a target voltage range, which is set based on the output voltage of the first battery. The controller includes a voltage increasing unit and a pre-charge controlling unit. The voltage increasing unit is configured to acquire the output voltage of the converter and to perform the voltage increasing operation of the converter until the output voltage of the converter becomes a value within the target voltage range. The pre-charge controlling unit is configured to acquire the output voltage of the first battery and the charged voltage of the capacitor, to cause the voltage increasing unit to perform the voltage increasing operation of the converter, and to control switching of the relay. The pre-charge controlling unit is configured to output a converter controlling signal, which is related to the output voltage of the converter, to the voltage increasing unit in a case in which the voltage increasing unit is caused to perform the voltage increasing operation of the converter under a situation in which an acquisition failure has occurred in which the voltage increasing unit is unable to acquire the output voltage of the converter. The voltage increasing unit is configured to stop the voltage increasing operation of the converter based on the converter controlling signal delivered from the pre-charge controlling unit. The pre-charge controlling unit is configured to, after the charged voltage of the capacitor shifts from an increase to a decrease in response to stopping of the voltage increasing operation of the converter, refrain from switching the relay when the charged voltage of the capacitor is out of the target voltage range, and establish the electrical connection of the relay when the charged voltage of the capacitor becomes a value within the target voltage range.

With the above-described configuration, in a case in which an acquisition failure occurs, in which the voltage increasing unit cannot acquire the output voltage of the converter, the pre-charge controlling unit refrains from switching the relay if the charged voltage of the capacitor is a value outside the target voltage range after the output voltage of the capacitor exceeds the target voltage range. When the charged voltage of the capacitor becomes a value within the target voltage range, the pre-charge controlling unit establishes the electrical connection of the relay. Accordingly, even if an acquisition failure occurs, the electrical connection of the relay is established at an appropriate point in time at which the output voltage of the converter becomes a value within the target voltage range.

In the controller for a power supply circuit, the pre-charge controlling unit may be configured to output, as the converter controlling signal, a stop signal that stops the voltage increasing operation of the converter to the voltage increasing unit when the charged voltage of the capacitor reaches the output voltage of the first battery.

With the above-described configuration, the pre-charge controlling unit determines the point in time at which the voltage increasing operation of the converter should be stopped based on the charged voltage of the capacitor. Accordingly, even if an acquisition failure occurs, the voltage increasing operation of the converter is stopped at an appropriate point in time with reference to the output voltage of the first battery.

In the controller for a power supply circuit, the capacitor is a first capacitor, and the converter is a first converter. The controller further includes a second capacitor and a second converter. The second capacitor is located between the first capacitor and the load and is connected in parallel with the first capacitor. The second converter is connected across the first capacitor and the second capacitor. The second converter is configured to increase the output voltage of the first battery and to output the increased output voltage to the load. The second converter includes a diode that is configured to allow for flow of current from the first capacitor to the second capacitor, while prohibiting flow of current from the second capacitor to the first capacitor. The pre-charge controlling unit may be configured to establish, after outputting the stop signal to the voltage increasing unit, the electrical connection of the relay when a charged voltage of the first capacitor or a charged voltage of the second capacitor is a value higher than the output voltage of the first battery.

With the above-described configuration, when the first converter is driven to perform the voltage increasing operation, the power output by the first converter is delivered not only to the first capacitor, but also to the second capacitor via the diode. Thus, when the first converter is driven to perform the voltage increasing operation, the first capacitor and the second capacitor are both charged. The charged voltage of the first capacitor and the charged voltage of the second capacitor become substantially equal to each other.

An example assumes that the electrical connection of the relay is established in a state in which the charged voltages of the first capacitor and the second capacitor are lower than the output voltage of the first battery in the target voltage range. In this case, current flows from the first battery to the load. At this time, the first battery is capable of energizing not only the first capacitor, but also the second capacitor via the diode. In this case, current that corresponds to the total electrostatic energy possessed by the first capacitor and the second capacitor flows from the first battery to the load. Accordingly, current of a significant magnitude flows through the relay.

In contrast, in the above-described configuration, the electrical connection of the relay is established in a state in which the charged voltages of the first capacitor and the second capacitor are higher than the output voltage of the first battery in the target voltage range. In this case, current flows from the load to the first battery. At this time, the diode prohibits current from flowing from the second capacitor to the first battery. Accordingly, current that corresponds to the capacitance energy stored in the first capacitor flows to the first battery. Therefore, the current flowing through the relay is smaller than in a case in which the electrical connection of the relay is established in a state in which the charged voltages of the first capacitor and the second capacitor are lower than the output voltage of the first battery. This reduces the risk of fusing of the relay.

In the controller for a power supply circuit, the pre-charge controlling unit may be configured to establish the electrical connection of the relay when the charged voltage of the first capacitor, which is one of the charged voltage of the first capacitor and the charged voltage of the second capacitor, is a value higher than the output voltage of the first battery.

When the first capacitor and the second capacitor are discharged after the voltage increasing operation of the first converter is stopped, the amounts of decrease in the charged voltages per unit time differ depending on the capacitances of the capacitors. The second capacitor, which is placed between the second converter and the load, is required to have a relatively large capacitance capable of storing drive power for the load. On the other hand, the first capacitor, which is connected to the first battery, is required to have a relatively small capacitance capable of storing power supplied from the first battery. Due to differences, including the difference in the capacitance, the capacitances of individual products used as the first capacitor in the power supply circuit may vary less than in the case of the second capacitor. Therefore, as far as the first capacitor is concerned, the amount of decrease in the charged voltage after a voltage increasing operation by the bidirectional converter is stopped does not vary significantly among the individual products, so that the point in time of switching of the relay is roughly determined. This is favorable in carrying out various types of control in a consistent manner before and after switching of the relay.

In another general aspect, a non-transitory computer readable storage medium is provided that stores a program that causes a controller to execute a process that controls a power supply circuit. The power supply circuit includes a first battery, a battery voltage sensor configured to detect an output voltage of the first battery, a relay configured to selectively establish and break an electrical connection from the first battery to a load, a second battery having a rated voltage lower than a rated voltage of the first battery, a converter configured to increase an output voltage of the second battery and to output the increased output voltage to a section between the relay and the load, a converter voltage sensor configured to detect an output voltage of the converter, a capacitor that is located between the relay and the load and is connected to the relay, and a capacitor voltage sensor configured to detect a charged voltage of the capacitor. The process includes a pre-charge process, a voltage increasing operation process, and a pre-charge control process. The pre-charge process performs, in a state in which the electrical connection between the first battery and the load is broken by the relay, a voltage increasing operation of the converter until the output voltage of the converter becomes a value within a target voltage range, which is set based on the output voltage of the first battery. The voltage increasing operation process acquires the output voltage of the converter and performs the voltage increasing operation of the converter until the output voltage of the converter becomes a value within the target voltage range. The pre-charge control process acquires the output voltage of the first battery and the charged voltage of the capacitor, causes the voltage increasing operation process to perform the voltage increasing operation of the converter, and controls switching of the relay. The pre-charge control process includes a process that outputs a converter controlling signal, which is related to the output voltage of the converter, in a case in which the voltage increasing operation process is caused to perform the voltage increasing operation of the converter under a situation in which an acquisition failure has occurred in which the output voltage of the converter cannot be acquired in the voltage increasing operation process. The voltage increasing operation process includes a process that stops the voltage increasing operation of the converter based on the converter controlling signal delivered in the pre-charge control process. The pre-charge control process includes a process that, after the charged voltage of the capacitor shifts from an increase to a decrease in response to stopping of the voltage increasing operation of the converter, refrains from switching the relay when the charged voltage of the capacitor is out of the target voltage range, and establishes the electrical connection of the relay when the charged voltage of the capacitor becomes a value within the target voltage range.

With the above-described configuration, in a case in which an acquisition failure occurs, switching of the relay is refrained if the charged voltage of the capacitor is a value outside the target voltage range after the output voltage of the converter exceeds the target voltage range. The electrical connection of the relay is established when the charged voltage of the capacitor becomes a value within the target voltage range. Accordingly, even if an acquisition failure occurs, the electrical connection of the relay is established at an appropriate point in time, at which the output voltage of the converter becomes a value within the target voltage range.

In another general aspect, a method for controlling a power supply circuit is provided. The power supply circuit includes a first battery, a battery voltage sensor configured to detect an output voltage of the first battery, a relay configured to selectively establish and break an electrical connection from the first battery to a load, a second battery having a rated voltage lower than a rated voltage of the first battery, a converter that increases an output voltage of the second battery and outputs the increased output voltage to a section between the relay and the load, a converter voltage sensor configured to detect an output voltage of the converter, a capacitor that is located between the relay and the load and is connected to the relay, and a capacitor voltage sensor configured to detect a charged voltage of the capacitor. The method includes: executing a pre-charge process that performs, in a state in which the electrical connection between the first battery and the load is broken by the relay, a voltage increasing operation of the converter until the output voltage of the converter becomes a value within a target voltage range, which is set based on the output voltage of the first battery; executing a voltage increasing operation process that acquires the output voltage of the converter and performs the voltage increasing operation of the converter until the output voltage of the converter becomes a value within the target voltage range; and executing a pre-charge control process that acquires the output voltage of the first battery and the charged voltage of the capacitor, causes the voltage increasing operation process to perform the voltage increasing operation of the converter, and controls switching of the relay. The pre-charge control process includes outputting a converter controlling signal, which is related to the output voltage of the converter, in a case in which the voltage increasing operation process is caused to perform the voltage increasing operation of the converter under a situation in which an acquisition failure has occurred in which the output voltage of the converter cannot be acquired in the voltage increasing operation process. The voltage increasing operation process includes stopping the voltage increasing operation of the converter based on the converter controlling signal delivered in the pre-charge control process. After the charged voltage of the capacitor shifts from an increase to a decrease in response to stopping of the voltage increasing operation of the converter, the pre-charge control process refrains from switching the relay when the charged voltage of the capacitor is out of the target voltage range, and establishes the electrical connection of the relay when the charged voltage of the capacitor becomes a value within the target voltage range.

Other features and aspects will be apparent from the following detailed description, the drawings, and the claims.

### BRIEF DESCRIPTION OF THE DRAWINGS

FIG. 1 is a schematic diagram of an electric power system of a vehicle.

FIG. 2 is a flowchart showing the procedure of a pre-charge process for normal state.

FIG. 3 is a flowchart showing the procedure of a pre-charge process for occurrence of failure.

FIG. 4 is a timing diagram showing examples of changes over time of various parameters related to the pre-charge process for occurrence of failure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

Controllers for a power supply circuit 16 according to an embodiment will now be described with reference to the drawings.

First, the schematic configuration of an electric power system mounted on a hybrid vehicle (hereinafter, simply referred to as a vehicle 10) will be described.

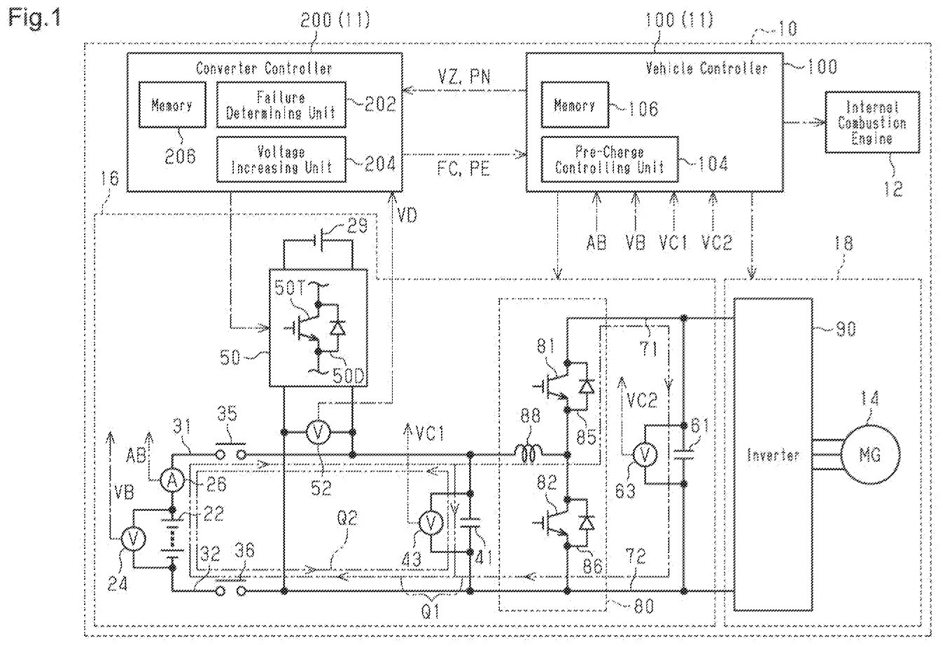

As shown in FIG. 1, the vehicle 10 includes an internal combustion engine 12, which is a drive source of the vehicle 10. The vehicle 10 also includes a motor generator 14, which is a drive source different from the internal combustion engine 12. The motor generator 14 functions as both a motor and a generator.

The vehicle 10 also includes a first battery 22, which is a rechargeable battery that supplies power to and receives power from the motor generator 14. That is, the first battery 22 supplies power to the motor generator 14 and stores power generated by the motor generator 14. The first battery 22 is a driving battery for the vehicle 10, and its rated voltage is, for example, in the range from 200 [V] to 250 [V]. A first battery voltage sensor 24, which detects an output voltage VB of the first battery 22, is connected across the terminals of the first battery 22.

The first battery 22 is connected to a buck-boost converter 80 via a couple of power lines. The buck-boost converter 80 raises and/or lowers voltage and outputs the voltage. Specifically, the positive electrode terminal of the first battery 22 is connected to the buck-boost converter 80 via a first positive electrode line 31. The negative electrode terminal of the first battery 22 is connected to the buck-boost converter 80 via a first negative electrode line 32.

A current sensor 26 is provided on the first positive electrode line 31. The current sensor 26 detects a charge-discharge current AB that flows in the first battery 22.

A positive electrode relay 35 is attached to a section of the first positive electrode line 31 between the current sensor 26 and the buck-boost converter 80. The positive electrode relay 35 selectively establishes and breaks the electrical connection between the first battery 22 and the buck-boost converter 80. A negative electrode relay 36 is attached to a section of the first negative electrode line 32. The negative electrode relay 36 selectively establishes and breaks the electrical connection between the first battery 22 and the buck-boost converter 80. When the positive electrode relay 35 and the negative electrode relay 36 are in a disconnecting state, the electrical connection between the first battery 22 and the buck-boost converter 80 is broken. When the positive electrode relay 35 and the negative electrode relay 36 are in a connecting state, the electrical connection is established between the first battery 22 and the buck-boost converter 80.

The first positive electrode line 31 and the first negative electrode line 32 are connected to a bidirectional converter 50. Specifically, one end of the bidirectional converter 50 is connected to a section of the first positive electrode line 31 between the positive electrode relay 35 and the buck-boost converter 80. The other end of the bidirectional converter 50 is connected to a section of the first negative electrode line 32 between the negative electrode relay 36 and the buck-boost converter 80. The bidirectional converter 50 is connected to a second battery 29, which is a rechargeable battery. The second battery 29 is used to drive auxiliary devices, and its rated voltage is, for example, in the range from 12 [V] to 48 [V].

Although not illustrated in detail, the bidirectional converter 50 includes transistors 50T, which are switching elements, and freewheeling diodes 50D. Each transistor 50T is connected in parallel with the corresponding diode 50D. The bidirectional converter 50 raises and/or lowers voltage and outputs the voltage. Specifically, the bidirectional converter 50 raises the output voltage of the second battery 29 and outputs the voltage to the first positive electrode line 31 and the first negative electrode line 32. Also, the bidirectional converter 50 lowers the voltage of the first positive electrode line 31 and the first negative electrode line 32 and outputs the voltage to the second battery 29. A converter voltage sensor 52 is connected to the bidirectional converter 50. The converter voltage sensor 52 detects, as a converter output voltage VD, an output voltage from the bidirectional converter 50 to the first positive electrode line 31 and the first negative electrode line 32.

A first capacitor 41 is connected to the first positive electrode line 31 and the first negative electrode line 32. The first capacitor 41 smooths the voltage between the first battery 22 and the buck-boost converter 80. Specifically, one end of the first capacitor 41 is connected to a section of the first positive electrode line 31 between the buck-boost converter 80 and the connecting point with the bidirectional converter 50. The other end of the first capacitor 41 is connected to a section of the first negative electrode line 32 between the buck-boost converter 80 and the connecting point with the bidirectional converter 50. That is, the first capacitor 41 is connected to the positive electrode relay 35 via the first positive electrode line 31 in a section between the positive electrode relay 35 and the buck-boost converter 80. The first capacitor 41 is also connected to the negative electrode relay 36 via the first negative electrode line 32 in a section between the negative electrode relay 36 and the buck-boost converter 80. A first capacitor voltage sensor 43, which detects a charged voltage VC1 of the first capacitor 41, is connected across the terminals of the first capacitor 41.

The buck-boost converter 80 includes a first transistor 81 and a second transistor 82, which are switching elements and connected to each other in series. The first transistor 81 and the second transistor 82 are both NPN transistors. The first transistor 81 is connected in parallel with a freewheeling first diode 85. The second transistor 82 is connected in parallel with a freewheeling second diode 86.

The connecting point of the emitter terminal of the first transistor 81 and the collector terminal of the second transistor 82 is connected to the first positive electrode line 31 via a reactor 88. The collector terminal of the first transistor 81 is connected to an inverter 90 via a second positive electrode line 71. The emitter terminal of the second transistor 82 is connected to the first negative electrode line 32, and to the inverter 90 via a second negative electrode line 72. Although not illustrated, the base terminal of the first transistor 81 and the base terminal of the second transistor 82 receive control voltage that selectively switches on and off the transistors 81, 82.

With the above-described connection, the buck-boost converter 80 raises the output voltage VB of the first battery 22 and outputs the output voltage VB to the inverter 90, and lowers the voltage output by the inverter 90 and outputs the voltage to the first battery 22. The inverter 90 is connected to the motor generator 14. The inverter 90 switches between direct-current power and alternate-current power between the buck-boost converter 80 and the motor generator 14.

A second capacitor 61 is connected to the second positive electrode line 71 and the second negative electrode line 72. The second capacitor 61 smooths the voltage between the buck-boost converter 80 and the inverter 90. That is, the second capacitor 61 is connected in parallel with the first capacitor 41 with the buck-boost converter 80 in between. The first transistor 81 and the first diode 85 of the buck-boost converter 80 are interposed between the second positive electrode line 71, which is connected to the second capacitor 61, and the first positive electrode line 31, which is connected to the first capacitor 41. The first diode 85, which is a freewheeling element for the first transistor 81, allows for flow of current from the emitter terminal to the collector terminal of the first transistor 81, while prohibiting flow of current in the reverse direction. That is, the first diode 85 allows for flow of current from the first capacitor 41 to the second capacitor 61, while prohibiting flow of current from the second capacitor 61 to the first capacitor 41.

A second capacitor voltage sensor 63, which detects a charged voltage VC2 of the second capacitor 61, is connected across the terminals of the second capacitor 61.

In the present embodiment, the electrical system between the inverter 90 and the first battery 22 forms a power supply circuit 16. That is, the power supply circuit 16 includes the first battery 22, the first battery voltage sensor 24, the current sensor 26, the first positive electrode line 31, the first negative electrode line 32, the positive electrode relay 35, and the negative electrode relay 36. The power supply circuit 16 also includes the first capacitor 41, the first capacitor voltage sensor 43, the second capacitor 61, the second capacitor voltage sensor 63, the second positive electrode line 71, and the second negative electrode line 72. The power supply circuit 16 further includes the second battery 29, the bidirectional converter 50, the converter voltage sensor 52, and the buck-boost converter 80. The bidirectional converter 50 is a first converter, and the buck-boost converter 80 is a second converter.

In the present embodiment, the inverter 90 and the motor generator 14 form an electrical load (hereinafter, simply referred to as a load) 18. The load 18 and the power supply circuit 16 form an electric power system. The positive electrode relay 35 and the negative electrode relay 36, which are interposed between the first battery 22 and the buck-boost converter 80, substantially selectively establish and break the electrical connection between the first battery 22 and the load 18.

Next, the control configuration of the vehicle 10 will be described.

The vehicle 10 is equipped with a vehicle controller 100, which controls various components of the vehicle 10 including the electric power system. The vehicle 10 is also equipped with a converter controller 200, which controls the bidirectional converter 50. The converter controller 200 is a controller dedicated for the bidirectional converter 50. The vehicle controller 100 is a high-order controller in relation to the converter controller 200, and controls the converter controller 200 to control the bidirectional converter 50. The vehicle controller 100 and the converter controller 200 form a power supply controller 11, which controls the power supply circuit 16.

The vehicle controller 100 and the converter controller 200 may each include one or more processors that perform various processes according to computer programs (software). The vehicle controller 100 and the converter controller 200 may each be circuitry including one or more dedicated hardware circuits such as application specific integrated circuits (ASIC) that execute at least part of various processes, or a combination thereof. The processors include CPUs. The vehicle controller 100 includes a memory 106 such as a RAM and a ROM. The converter controller 200 includes a memory 206 such as a RAM and a ROM. The memories 106, 206 each store program codes or commands configured to cause the CPU to execute power supply circuit control programs. The memories 106, 206 include any type of available non-transitory computer readable storage medium that is accessible by a general-purpose computer or a dedicated computer.

The vehicle controller 100 receives detection signals from various sensors mounted on the vehicle 10. Specifically, the vehicle controller 100 receives the various signals below:

the output voltage VB of the first battery 22 detected by the first battery voltage sensor 24;

the charge-discharge current AB of the first battery 22 detected by the current sensor 26;

the charged voltage VC1 of the first capacitor 41 detected by the first capacitor voltage sensor 43; and

the charged voltage VC2 of the second capacitor 61 detected by the second capacitor voltage sensor 63.

Also, the converter controller 200 receives a signal related to the converter output voltage VD detected by the converter voltage sensor 52.

When an ignition switch G of the vehicle 10 is turned on, the electrical connection is established between the first battery 22 and the load 18 by means of the positive electrode relay 35 and the negative electrode relay 36 (hereinafter, simply referred to as the electrical connection of the positive electrode relay 35 and the negative electrode relay 36), so that power supply from the first battery 22 to the load 18 is started. At this time, if a high current instantaneously flows from the first battery 22, which has a high voltage, to the load 18, the positive electrode relay 35 and the negative electrode relay 36 may fuse. In this regard, before starting the supply of power from the first battery 22 to the load 18, a process needs to be executed to charge the first capacitor 41 in a state in which the electrical connection of the positive electrode relay 35 and the negative electrode relay 36 are broken. If the first capacitor 41 is charged, the voltage difference between the first battery 22 and the first capacitor 41 is reduced. This reduces the current flowing through the positive electrode relay 35 and the negative electrode relay 36.

The vehicle controller 100 includes a pre-charge controlling unit 104, which controls a pre-charge process that charges the first capacitor 41. In the pre-charge process, the bidirectional converter 50 continues a voltage increasing operation until the converter output voltage VD becomes a value within a target voltage range VZ, which is determined based on the output voltage VB of the first battery 22, in a state in which the electrical connection of the positive electrode relay 35 and the negative electrode relay 36 are broken. During the execution of the pre-charge process, the charged voltage VC1 of the first capacitor 41 is substantially equal to the converter output voltage VD. When the pre-charge process is executed, the buck-boost converter 80 and the inverter 90 are not operating. At this time, the first positive electrode line 31 and the second positive electrode line 71 are connected to each other via the first diode 85, so that the charged voltage VC2 of the second capacitor 61 and the converter output voltage VD are substantially equal to each other. Accordingly, in the pre-charge process, the charged voltage VC1 of the first capacitor 41 and the charged voltage VC2 of the second capacitor 61 are raised to the target voltage range VZ.

The pre-charge controlling unit 104 is capable of executing a pre-charge control process, which is the basis of the pre-charge process. The pre-charge controlling unit 104 calculates the target voltage range VZ in the pre-charge control process. The pre-charge controlling unit 104 also outputs a command signal to the converter controller 200 in the pre-charge control process, thereby causing the converter controller 200 to execute the voltage increasing operation of the bidirectional converter 50. Further, the pre-charge controlling unit 104 controls switching of the positive electrode relay 35 and the negative electrode relay 36 in the pre-charge control process.

An acquisition failure may occur in which the converter controller 200 cannot acquire the converter output voltage VD. When driving the bidirectional converter 50 to perform the voltage increasing operation in a situation in which there is no acquisition failure, the pre-charge controlling unit 104 leaves, to the converter controller 200, the determination of whether charging of the first capacitor 41 by the bidirectional converter 50 has been completed. In contrast, when driving the bidirectional converter 50 to perform the voltage increasing operation in a situation in which an acquisition failure is occurring, the pre-charge controlling unit 104 uses the charged voltage VC1 of the first capacitor 41 to determine by itself whether the voltage increasing operation by the bidirectional converter 50 has been completed. When the charged voltage VC1 of the first capacitor 41 reaches the output voltage VB of the first battery 22, the pre-charge controlling unit 104 outputs, to the converter controller 200, a converter controlling signal, which is a signal related to the converter output voltage VD. In the present embodiment, the converter controlling signal is a signal for stopping the increase of the converter output voltage VD. Specifically, the pre-charge controlling unit 104 outputs, to the converter controller 200, the converter controlling signal as a stop signal PN that stops the voltage increasing operation of the bidirectional converter 50.

When outputting the stop signal PN, the pre-charge controlling unit 104 refrains from switching the positive electrode relay 35 and the negative electrode relay 36 if the charged voltage VC1 of the first capacitor 41 is out of the target voltage range VZ after the charged voltage VC1 of the first capacitor 41 shifts from an increase to a decrease in response to stopping of the voltage increasing operation of the bidirectional converter 50. When the charged voltage VC1 of the first capacitor 41 becomes a value within the target voltage range VZ, the pre-charge controlling unit 104 establishes the electrical connection of the positive electrode relay 35 and the negative electrode relay 36. Specifically, the pre-charge controlling unit 104 establishes the electrical connection of the positive electrode relay 35 and the negative electrode relay 36 when the charged voltage VC1 of the first capacitor 41 is a value within the target voltage range VZ, and higher than the output voltage VB of the first battery 22.

The converter controller 200 includes a failure determining unit 202, which determines whether an acquisition failure is occurring, in which the converter output voltage VD cannot be acquired.

The converter controller 200 also includes a voltage increasing unit 204, which controls the voltage increasing operation of the bidirectional converter 50. The voltage increasing unit 204 is capable of executing the voltage increasing operation process, which executes the voltage increasing operation by the bidirectional converter 50 in response to a command from the pre-charge controlling unit 104. In the voltage increasing operation process in a situation in which an acquisition failure is not occurring, the voltage increasing unit 204 acquires the converter output voltage VD and drives the bidirectional converter 50 to perform the voltage increasing operation until the converter output voltage VD becomes a value within the target voltage range VZ. In contrast, in the voltage increasing operation process in a situation in which an acquisition failure is occurring, the voltage increasing unit 204 stops the voltage increasing operation of the bidirectional converter 50 when acquiring the stop signal PN from the pre-charge controlling unit 104 of the vehicle controller 100. That is, the voltage increasing unit 204 stops the voltage increasing operation of the bidirectional converter 50 based on the stop signal PN, which is a converter controlling signal from the pre-charge controlling unit 104.

Next, a determination process that determines whether there is an acquisition failure executed by the failure determining unit 202 of the converter controller 200 will be described. The failure determining unit 202 repeats the process that determines whether there is an acquisition failure during a period from when the ignition switch G is turned on to when the ignition switch G is turned off. As a precondition of the determination process, the failure determining unit 202 repeatedly receives the converter output voltage VD detected by the converter voltage sensor 52.

The failure determining unit 202 determines that an acquisition failure is occurring when a determination condition is met that a situation in which the converter output voltage VD cannot be acquired from the converter voltage sensor 52 has continued for a predetermined amount of time. The predetermined amount of time is set to be sufficiently longer than the reception cycle for the converter output voltage VD at the failure determining unit 202. The situation in which the failure determining unit 202 cannot acquire the converter output voltage VD occurs, for example, when a communication failure occurs due to a broken communication line between the converter voltage sensor 52 and the converter controller 200, or due to a connector of the communication line being detached from the input port of the converter controller 200.

Also, even if the converter output voltage VD can be acquired from the converter voltage sensor 52, the failure determining unit 202 determines that an acquisition failure has occurred when a determination condition is met that the converter output voltage VD is a value out of a predetermined normal range. The normal range is set to a range of values normally assumed by the converter output voltage VD. A situation in which the converter output voltage VD is out of the normal range occurs, for example, when a failure occurs in the converter voltage sensor 52 so that the converter voltage sensor 52 cannot properly detect the converter output voltage VD.

The failure determining unit 202 determines that an acquisition failure is not occurring when none of the above determination conditions are met. When determining whether there is an acquisition failure, the failure determining unit 202 sets an acquisition failure occurrence flag FC, which indicates the determination result. When determining that an acquisition failure is occurring, the failure determining unit 202 turns on the acquisition failure occurrence flag FC. When determining that an acquisition failure is not occurring, the failure determining unit 202 turns off the acquisition failure occurrence flag FC. After setting the acquisition failure occurrence flag FC, the failure determining unit 202 outputs the acquisition failure occurrence flag FC to the vehicle controller 100.

Next, the pre-charge control process executed by the pre-charge controlling unit 104 of the vehicle controller 100 and the voltage increasing operation process executed by the voltage increasing unit 204 of the converter controller 200 in conjunction with the pre-charge control process will be described. The pre-charge control process differs between a pre-charge control process for normal state, which is executed in a situation in which an acquisition failure is not occurring, and a pre-charge control pre-charge control process for occurrence of failure, which is executed in a situation in which an acquisition failure is occurring. The same applies to the voltage increasing operation process. Below, the pre-charge control process and the voltage increasing operation process for normal state will be first described. Thereafter, the pre-charge control process and the voltage increasing operation process for occurrence of failure will be described. The pre-charge control process and the voltage increasing operation process are executed only once during a period from when the ignition switch G is turned on to when it is turned off, whether in normal time or when there is a failure. With regard to control processes related to the power supply circuit 16, the control through the pre-charge control process and the control through the voltage increasing operation process are prioritized over the control through other processes.

The pre-charge control process for normal state will now be described. When the ignition switch G is turned on, the pre-charge controlling unit 104 of the vehicle controller 100 initiates the pre-charge control process for normal state on condition that the acquisition failure occurrence flag FC is off. The electrical connection of the positive electrode relay 35 and the negative electrode relay 36 has been broken at the point in time at which the ignition switch G is turned on.

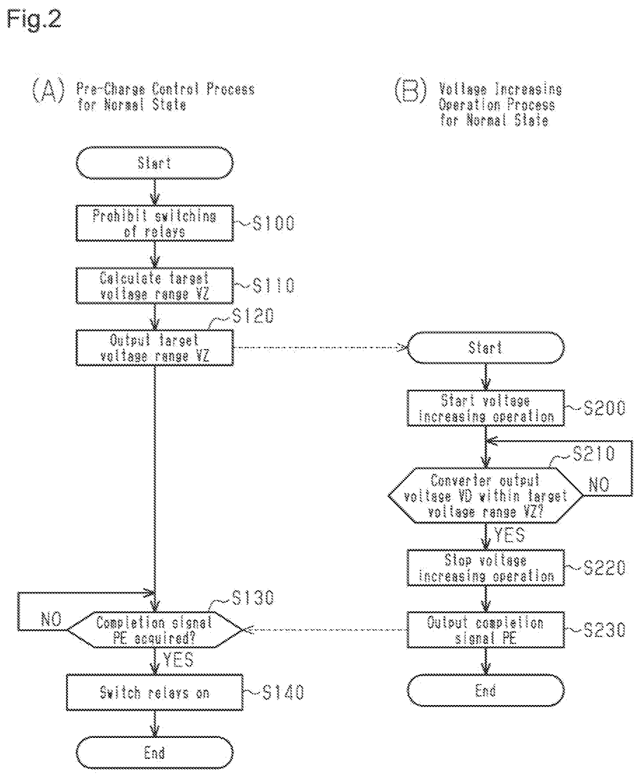

As shown in section (A) of FIG. 2, the pre-charge controlling unit 104 executes the process of step S100 when starting the pre-charge control process for normal state. In step S100, the pre-charge controlling unit 104 prohibits switching of the positive electrode relay 35 and the negative electrode relay 36. That is, the pre-charge controlling unit 104 maintains the state in which the electrical connection of the positive electrode relay 35 and the negative electrode relay 36 are broken. After executing the process of step S100, the pre-charge controlling unit 104 advances the process to step S110.

In step S110, the pre-charge controlling unit 104 calculates the target voltage range VZ. Specifically, the pre-charge controlling unit 104 acquires the latest value of the output voltage VB of the first battery 22 detected by the first battery voltage sensor 24. The pre-charge controlling unit 104 calculates the output voltage VB of the first battery 22 as a lower limit VZ1 of the target voltage range VZ. Also, the pre-charge controlling unit 104 adds a permissible voltage difference VP to the output voltage VB of the first battery 22 and obtains the resultant as an upper limit VZ2 of the target voltage range VZ. The pre-charge controlling unit 104 stores the permissible voltage difference VP in advance. A limit value of the voltage difference between the first battery 22 and the first capacitor 41 is defined as a voltage difference limit VPM, at which the positive electrode relay 35 and the negative electrode relay 36 do not fuse when the electrical connection of the positive electrode relay 35 and the negative electrode relay 36 is established. The permissible voltage difference VP is set to be slightly less than the voltage difference limit VPM through experiments and/or simulations. After executing the process of step S110, the pre-charge controlling unit 104 advances the process to step S120. During the execution of the pre-charge control process for normal state, the output voltage VB of the first battery 22 is maintained without being changed.

In step S120, the pre-charge controlling unit 104 outputs, to the converter controller 200, the target voltage range VZ as a signal that commands execution of a voltage increasing operation of the bidirectional converter 50. Thereafter, the pre-charge controlling unit 104 advances the process to step S130.

In step S130, the pre-charge controlling unit 104 determines whether it has acquired a completion signal PE, which indicates that a voltage increase by the bidirectional converter 50 has been completed. The completion signal PE is output by the voltage increasing unit 204 of the converter controller 200 in a voltage increasing operation process for normal state, which will be discussed below. If it has not acquired the completion signal PE (step S130: NO), the pre-charge controlling unit 104 executes the process of step S130 again. The pre-charge controlling unit 104 repeats the process of step S130 until acquiring the completion signal PE. When acquiring the completion signal PE (step S130: YES), the pre-charge controlling unit 104 advances the process to step S140.

In step S140, the pre-charge controlling unit 104 establishes the electrical connection of the positive electrode relay 35 and the negative electrode relay 36. The pre-charge controlling unit 104 then ends the series of processes of the pre-charge control process for normal state.

The voltage increasing operation process for normal state will now be described. As shown in section (B) of FIG. 2, the voltage increasing unit 204 of the converter controller 200 starts this process in reaction to the process of step S120 in the pre-charge control process for normal state. Specifically, when acquiring the target voltage range VZ output by the pre-charge controlling unit 104, the voltage increasing unit 204 starts this process on condition that the acquisition failure occurrence flag FC is off.

When starting the voltage increasing operation process for normal state, the voltage increasing unit 204 executes the process of step S200. In step S200, the voltage increasing unit 204 starts the voltage increasing operation of the bidirectional converter 50. After executing the process of step S200, the voltage increasing unit 204 advances the process to step S210.

In step S210, the voltage increasing unit 204 determines whether the converter output voltage VD is a value within the target voltage range VZ. Specifically, the voltage increasing unit 204 acquires the latest value of the converter output voltage VD detected by the converter voltage sensor 52. The voltage increasing unit 204 compares the converter output voltage VD with the lower limit VZ1 and the upper limit VZ2 of the target voltage range VZ. If the converter output voltage VD is out of the target voltage range VZ (step S210: NO), the voltage increasing unit 204 executes the process of step S210 again. The voltage increasing unit 204 repeats the process of step S210 until the converter output voltage VD becomes a value within the target voltage range VZ. When the converter output voltage VD is a value within the target voltage range VZ (step S210: YES), the voltage increasing unit 204 advances the process to step S220.

In step S220, the voltage increasing unit 204 stops the voltage increasing operation of the bidirectional converter 50. The voltage increasing unit 204 then advances the process to step S230.

In step S230, the voltage increasing unit 204 outputs, to the vehicle controller 100, the completion signal PE, which indicates that the voltage increase by the bidirectional converter 50 has been completed. Thereafter, the voltage increasing unit 204 ends the series of processes of the voltage increasing operation process for normal state. As described above, the pre-charge process for normal state includes the series of processes of the pre-charge control process for normal state and the series of processes of the voltage increasing operation process for normal state.

Next, the pre-charge control process for occurrence of failure will now be described. When the ignition switch G is turned on, the pre-charge controlling unit 104 of the vehicle controller 100 initiates the pre-charge control process for occurrence of failure on condition that the acquisition failure occurrence flag FC is on. As described above, the electrical connection of the positive electrode relay 35 and the negative electrode relay 36 has been broken at the point in time at which the ignition switch G is turned on.

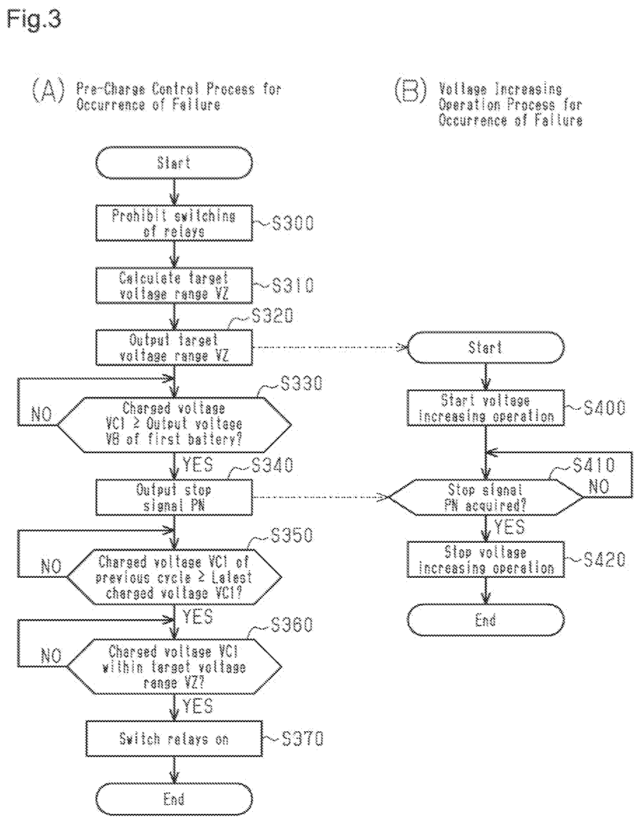

As shown in section (A) of FIG. 3, the pre-charge controlling unit 104 executes the process of step S300 when starting the pre-charge control process for occurrence of failure. In step S300, the pre-charge controlling unit 104 prohibits switching of the positive electrode relay 35 and the negative electrode relay 36. Thereafter, the pre-charge controlling unit 104 advances the process to step S310.

In step S310, the pre-charge controlling unit 104 calculates the target voltage range VZ. The method of calculating the target voltage range VZ is the same as that in the case of the pre-charge control process for normal state. The description thereof is thus omitted. As in the case of the pre-charge control process for normal state, the output voltage VB of the first battery 22 is constant during the execution of the pre-charge control process for occurrence of failure. After executing the process of step S310, the pre-charge controlling unit 104 advances the process to step S320.

In step S320, the pre-charge controlling unit 104 outputs, to the converter controller 200, the target voltage range VZ as a signal that commands execution of a voltage increasing operation of the bidirectional converter 50. Thereafter, the pre-charge controlling unit 104 advances the process to step S330.

In step S330, the pre-charge controlling unit 104 determines whether the charged voltage VC1 of the first capacitor 41 is higher than or equal to the output voltage VB of the first battery 22. Specifically, the pre-charge controlling unit 104 acquires the latest value of the charged voltage VC1 of the first capacitor 41 detected by the first capacitor voltage sensor 43. Also, the pre-charge controlling unit 104 acquires the latest value of the output voltage VB of the first battery 22 detected by the first battery voltage sensor 24. The pre-charge controlling unit 104 then compares the charged voltage VC1 of the first capacitor 41 and the output voltage VB of the first battery 22 with each other. When the charged voltage VC1 of the first capacitor 41 is lower than the output voltage VB of the first battery 22 (step S330: NO), the pre-charge controlling unit 104 executes the process of step S330 again. The pre-charge controlling unit 104 repeats the process of step S330 until the charged voltage VC1 of the first capacitor 41 becomes higher than or equal to the output voltage VB of the first battery 22. When the charged voltage VC1 of the first capacitor 41 is higher than or equal to the output voltage VB of the first battery 22 (step S330: YES), the pre-charge controlling unit 104 advances the process to step S340. Also, regarding the process of step S330, the pre-charge controlling unit 104 may use, as the voltage VB of the first battery 22, the lower limit VZ1 of the target voltage range VZ, which is equal to the output voltage VB of the first battery 22.

In step S340, the pre-charge controlling unit 104 outputs, to the converter controller 200, the stop signal PN for stopping the voltage increasing operation of the bidirectional converter 50. After executing the process of step S340, the pre-charge controlling unit 104 advances the process to step S350.

In step S350, the pre-charge controlling unit 104 determines whether the latest value of the charged voltage VC1 of the first capacitor 41 is lower than the charged voltage VC1 in the execution of step S350 of the previous cycle. Specifically, the pre-charge controlling unit 104 acquires the latest value of the charged voltage VC1 of the first capacitor 41 detected by the first capacitor voltage sensor 43. The pre-charge controlling unit 104 compares the acquired charged voltage VC1 and the charged voltage VC1 at the point in time at which the step S350 was executed in the previous cycle (hereinafter, referred to as the charged voltage VC1 of the previous cycle). The pre-charge controlling unit 104 treats the charged voltage VC1 of the previous cycle as 0 when executing the process of the step S350 for the first time after starting the pre-charge control process for occurrence of failure.

When the latest charged voltage VC1 is higher than or equal to the charged voltage VC1 of the previous cycle (step S350: NO), the pre-charge controlling unit 104 executes the process of step S350 again. The pre-charge controlling unit 104 repeats the process of step S350 until the latest charged voltage VC1 becomes lower than the charged voltage VC1 of the previous cycle. When the latest charged voltage VC1 becomes lower than the charged voltage VC1 of the previous cycle (step S350: YES), the pre-charge controlling unit 104 advances the process to step S360. The situation in which the determination of step S350 is NO, that is, the situation in which the latest charged voltage VC1 is higher than or equal to the charged voltage VC1 of the previous cycle, corresponds to a situation in which the charged voltage VC1 is increasing in changes over time of the charged voltage VC1. Also, the situation in which the determination of step S350 is switched from NO to YES, that is, the situation in which the latest charged voltage VC1 is switched from a value higher than or equal to the charged voltage VC1 of the previous cycle to a value lower than the charged voltage VC1 of the previous cycle, corresponds to a situation in which the charged voltage VC1 shifts from an increase to a decrease in changes over time of the charged voltage VC1.

The point in time at which the charged voltage VC1 of the first capacitor 41 shifts from an increase to a decrease corresponds to a point in time at which the voltage increase by the bidirectional converter 50 is actually stopped through various processes after the pre-charge controlling unit 104 outputs the stop signal PN in step S340. It has been discovered through experiments and/or simulations that the amount of increase of the converter output voltage VD from when the stop signal PN is output in step S340 to when the voltage increase by the bidirectional converter 50 is actually stopped is greater than the permissible voltage difference VP, which specifies the upper limit VZ2 of the target voltage range VZ. Thus, when the charged voltage VC1 of the first capacitor 41 shifts from an increase to a decrease (step S350: YES), the charged voltage VC1 of the first capacitor 41 exceeds the upper limit VZ2 of the target voltage range VZ.

In step S360, the pre-charge controlling unit 104 determines whether the charged voltage VC1 of the first capacitor 41 is a value within the target voltage range VZ. Specifically, the pre-charge controlling unit 104 acquires the latest value of the charged voltage VC1 of the first capacitor 41 detected by the first capacitor voltage sensor 43. The pre-charge controlling unit 104 compares the charged voltage VC1 with the lower limit VZ1 and the upper limit VZ2 of the target voltage range VZ. If the charged voltage VC1 is out of the target voltage range VZ (step S360: NO), the pre-charge controlling unit 104 executes the process of step S360 again. The pre-charge controlling unit 104 repeats the process of step S360 until the charged voltage VC1 becomes a value within the target voltage range VZ. When the charged voltage VC1 has become a value within the target voltage range VZ (step S360: YES), the pre-charge controlling unit 104 advances the process to step S370.

Taking the process of step S350 into consideration, the process of step S360 is executed when the charged voltage VC1 is decreasing toward the target voltage range VZ in changes over time of the charged voltage VC1. Thus, when the charged voltage VC1 is within the target voltage range VZ and relatively close to the upper limit VZ2, the pre-charge controlling unit 104 makes an affirmative determination (YES) in the process of step S360. In other words, when the charged voltage VC1 is higher than lower limit VZ1 of the target voltage range VZ, the pre-charge controlling unit 104 makes an affirmative determination (YES) in the process of step S360. The lower limit VZ1 of the target voltage range VZ is the output voltage VB of the first battery 22 during the execution of the pre-charge control process for occurrence of failure.

In step S370, the pre-charge controlling unit 104 establishes the electrical connection of the positive electrode relay 35 and the negative electrode relay 36. After executing the process of step S370, the pre-charge controlling unit 104 ends the series of processes of the pre-charge control process for occurrence of failure.

The voltage increasing operation process for occurrence of failure will now be described. As shown in section (B) of FIG. 3, the voltage increasing unit 204 of the converter controller 200 starts the voltage increasing operation process for occurrence of failure in reaction to the process of step S320 in the pre-charge control process for occurrence of failure. Specifically, when acquiring the target voltage range VZ output by the pre-charge controlling unit 104 of the vehicle controller 100, the voltage increasing unit 204 starts the voltage increasing operation process for occurrence of failure on condition that the acquisition failure occurrence flag FC is on.

When starting the voltage increasing operation process for occurrence of failure, the voltage increasing unit 204 executes the process of step S400. In step S400, the voltage increasing unit 204 starts the voltage increasing operation of the bidirectional converter 50. After executing the process of step S400, the voltage increasing unit 204 advances the process to step S410.

In step S410, the voltage increasing unit 204 determines whether it has acquired the stop signal PN for stopping the voltage increasing operation of the bidirectional converter 50. The stop signal PN is output by the pre-charge controlling unit 104 of the vehicle controller 100 in step S340 of the pre-charge control process for occurrence of failure. When it has not acquired the stop signal PN (step S410: NO), the voltage increasing unit 204 executes the process of step S410 again. The voltage increasing unit 204 repeats the process of step S410 until acquiring the stop signal PN. When acquiring the stop signal PN (step S410: YES), the voltage increasing unit 204 advances the process to step S420.

In step S420, the voltage increasing unit 204 stops the voltage increasing operation of the bidirectional converter 50. The converter controller 200 then ends the series of processes of the voltage increasing operation process for occurrence of failure. As described above, the pre-charge process for occurrence of failure includes the series of processes of the pre-charge control process for occurrence of failure and the series of processes of the voltage increasing operation process for occurrence of failure.

An operation of the present embodiment will now be described.

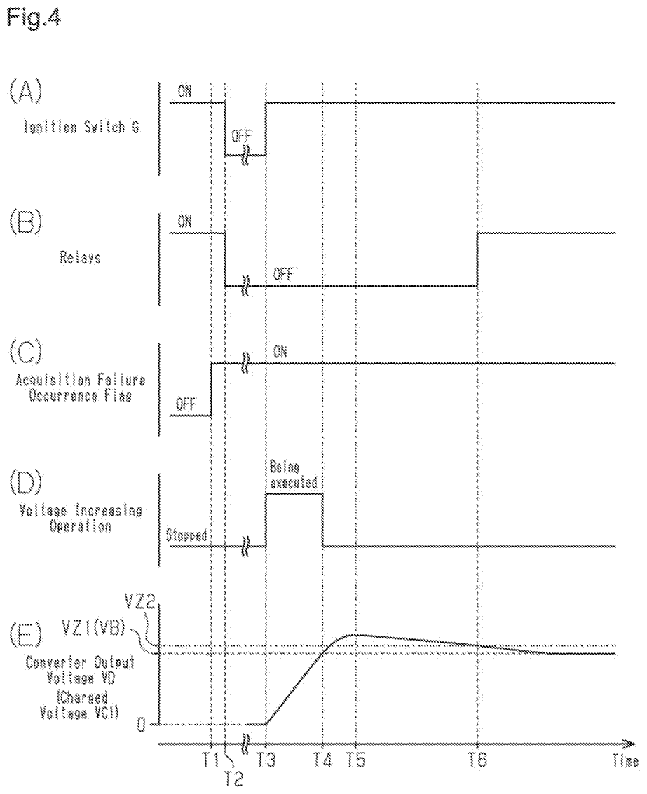

An example assumes that an acquisition failure occurs at a point in time T1 during traveling of the vehicle 10, and that the acquisition failure occurrence flag FC is switched from off to on as shown in section (C) of FIG. 4. Thereafter, as shown in section (A) of FIG. 4, the ignition switch G is turned OFF at a point in time T2, and the ignition switch G is then turned ON at a point in time T3. In response to the switching off of the ignition switch G at the point in time T2, the electrical connection of the positive electrode relay 35 and the negative electrode relay 36 is broken. The electrical connection of the positive electrode relay 35 and the negative electrode relay 36 remains broken at a point in time T3.

The example also assumes that, as shown in section (C) of FIG. 4, the acquisition failure continues after the point in time T3, at which the ignition switch G is turned on. In this case, when the ignition switch G is turned ON, the pre-charge process for occurrence of failure is executed. In response to output of the target voltage range VZ from the pre-charge controlling unit 104 (step S320), the voltage increasing unit 204 starts the voltage increasing operation of the bidirectional converter 50 (step S400) as shown in section (D) of FIG. 4. Section (D) of FIG. 4 indicates whether the voltage increasing operation is being performed for descriptive purposes. As shown in section (E) of FIG. 4, in response to turning OFF of the ignition switch G at the point in time T2, the converter output voltage VD remains zero until the point in time T3. When the bidirectional converter 50 starts the voltage increasing operation from the point in time T3 as described above, the converter output voltage VD increases from zero.

Thereafter, the pre-charge controlling unit 104 uses the charged voltage VC1 of the first capacitor 41 to repeatedly determine whether the voltage increase by the bidirectional converter 50 has been completed (step S330). At a point in time T4, at which the charged voltage VC1 of the first capacitor 41 reaches the output voltage VB of the first battery 22 in the pre-charge process (step S330: YES), the pre-charge controlling unit 104 outputs the stop signal PN (step S340). When receiving the stop signal PN, the voltage increasing unit 204 stops the voltage increasing operation of the bidirectional converter 50 as shown in section (D) of FIG. 4 (step S420).

After the point in time T4, at which the voltage increasing operation is stopped, the converter output voltage VD increases as shown in section (E) of FIG. 4 until switching of the transistors 50T in the bidirectional converter 50 is stopped, so that the voltage increase by the bidirectional converter 50 is actually stopped. During the increase, the converter output voltage VD exceeds the upper limit VZ2 of the target voltage range VZ. At a point in time T5, at which the voltage increase by the bidirectional converter 50 is stopped, the converter output voltage VD starts decreasing (step S350: YES).

Thereafter, the pre-charge controlling unit 104 repeatedly determines whether the charged voltage VC1 of the first capacitor 41 has become a value within the target voltage range VZ in a situation in which the charged voltage VC1 of the first capacitor 41 is decreasing toward the target voltage range VZ, together with the converter output voltage VD (step S360). The pre-charge controlling unit 104 refrains from switching the positive electrode relay 35 and the negative electrode relay 36 when the charged voltage VC1 of the first capacitor 41 is a value higher than the target voltage range VZ. The pre-charge controlling unit 104 then establishes the electrical connection of the positive electrode relay 35 and the negative electrode relay 36 at a point in time T6, at which the charged voltage VC1 of the first capacitor 41 becomes a value relatively close to the upper limit VZ2 of the target voltage range VZ (step S360: YES). That is, the pre-charge controlling unit 104 switches the positive electrode relay 35 and the negative electrode relay 36 when the charged voltage VC1 is higher than the output voltage VB of the first battery 22, which corresponds to the lower limit VZ1 of the target voltage range VZ.

After the point in time T6, at which the positive electrode relay 35 and the negative electrode relay 36 are switched on, the first battery 22 is electrically connected to a section of the power supply circuit 16 between the load 18 and the set of the positive electrode relay 35 and the negative electrode relay 36. Accordingly, the converter output voltage VD and the charged voltage VC1 of the first capacitor 41 become substantially equal to the output voltage VB of the first battery 22.

The present embodiment has the following advantages.

(1) With the above-described configuration, the voltage increasing operation of the bidirectional converter 50 is started and stopped by the voltage increasing unit 204 of the converter controller 200, which is a controller dedicated for the bidirectional converter 50. Under a situation in which an acquisition failure is occurring, the voltage increasing unit 204 cannot acquire the converter output voltage VD. The voltage increasing unit 204 thus cannot determine, by itself, the completion of the voltage increase by the bidirectional converter 50. Thus, when an acquisition failure is occurring, the pre-charge controlling unit 104 of the vehicle controller 100, not the voltage increasing unit 204, determines the completion of the voltage increase by the bidirectional converter 50 using the charged voltage VC1 of the first capacitor 41. In this case, when stopping the voltage increasing operation of the bidirectional converter 50, there is a certain delay until the voltage increasing operation of the bidirectional converter 50 is actually stopped after determination of the completion of the voltage increase, partly due to transfer of the stop signal PN between the pre-charge controlling unit 104 and the voltage increasing unit 204. The bidirectional converter 50 continues to increase the voltage during the delay. The converter output voltage VD thus exceeds the target voltage range VZ at a point in time at which the bidirectional converter 50 actually stops increasing the voltage. If the electrical connection of the positive electrode relay 35 and the negative electrode relay 36 is established at this point in time, these relays 35, 36 may fuse.

A comparative example assumes that it is possible to predict the rates of increase per unit time of the converter output voltage VD and the charged voltage VC1 of the first capacitor 41 due to the voltage increasing operation of the bidirectional converter 50. In this case, the amount of time from when the stop signal PN is output until when the voltage increasing operation by the bidirectional converter 50 is actually stopped can be used to set the output of the stop signal PN to an appropriate point in time before the charged voltage VC1 of the first capacitor 41 reaches the target voltage range VZ. This allows the converter output voltage VD and the charged voltage VC1 of the first capacitor 41 to be values within the target voltage range VZ when the voltage increasing operation by the bidirectional converter 50 is actually stopped. However, the rate of increase per unit time of the converter output voltage VD and/or the charged voltage VC1 of the first capacitor 41 due to the voltage increasing operation of the bidirectional converter 50 varies in correspondence with the capacitance of the first capacitor 41 and/or the second capacitor 61 used in the power supply circuit 16. In other words, the rate of increase varies depending on the individual products used in the power supply circuit 16. It is therefore substantially impossible to acquire the rate of increase in advance.

In this regard, the above-described configuration temporarily allows the converter output voltage VD and the charged voltage VC1 of the first capacitor 41 to exceed the upper limit VZ2 of the target voltage range VZ after it is determined that the voltage increase is completed. Then, the pre-charge controlling unit 104 refrains from switching the positive electrode relay 35 and the negative electrode relay 36 if the charged voltage VC1 of the first capacitor 41 is higher than the upper limit VZ2 of the target voltage range VZ after the charged voltage VC1 of the first capacitor 41 shifts from an increase to a decrease due to stopping of the voltage increasing operation of the bidirectional converter 50. When the charged voltage VC1 of the first capacitor 41 becomes a value within the target voltage range VZ, the pre-charge controlling unit 104 establishes the electrical connection of the positive electrode relay 35 and the negative electrode relay 36. Accordingly, even if an acquisition failure occurs, the above-described configuration is capable of establishing the electrical connection of the positive electrode relay 35 and the negative electrode relay 36 when the converter output voltage VD is a value within the target voltage range VZ. This prevents the positive electrode relay 35 and the negative electrode relay 36 from fusing when the positive electrode relay 35 and the negative electrode relay 36 are switched.

(2) With the above-described configuration, the power output by the bidirectional converter 50 when the bidirectional converter 50 performs the voltage increasing operation is delivered not only to the first capacitor 41, but also to the second capacitor 61 via the first diode 85. Thus, when the bidirectional converter 50 is driven to perform the voltage increasing operation, the first capacitor 41 and the second capacitor 61 are both charged.

An example assumes that the lower limit of the target voltage range VZ is set to a value lower than the output voltage VB of the first battery 22 during the pre-charge process. This example also assumes that the electrical connection of the positive electrode relay 35 and the negative electrode relay 36 is established in a state in which the charged voltage VC1 of the first capacitor 41 is lower than the output voltage VB of the first battery 22 within the target voltage range VZ. In this case, since the voltage of the first battery 22 is higher than that of the first capacitor 41, current flows from the first battery 22 to the first capacitor 41. The first diode 85 permits current to flow from the first capacitor 41 to the second capacitor 61. Thus, as indicated by the long-dash double-short-dash line Q1 in FIG. 1, the current flowing from the first battery 22 to the first capacitor 41 flows not only to the first capacitor 41, but also to the second capacitor 61 via the first diode 85. In this case, current that corresponds to the total electrostatic energy possessed by the first capacitor 41 and the second capacitor 61 flows to the power supply circuit 16. Accordingly, current of a significant magnitude flows through the positive electrode relay 35 and the negative electrode relay 36.

In contrast, the direction of the current flowing in the power supply circuit 16 is inverted from that in the above-described example when the positive electrode relay 35 and the negative electrode relay 36 are switched on in a state in which the charged voltage VC1 of the first capacitor 41 is higher than the output voltage VB of the first battery 22. Specifically, since the voltage of the first capacitor 41 is higher than that of the first battery 22, current flows from the first capacitor 41 to the first battery 22. At this time, the first diode 85 prohibits flow of current from the second capacitor 61 to the first battery 22. Thus, as indicated by the long-dash double-short-dash line Q2 in FIG. 1, current flows only between the first capacitor 41 and the first battery 22 in the power supply circuit 16. In this case, only the current that corresponds to the capacitance energy stored by the first capacitor 41 flows in the power supply circuit 16. Thus, the current flowing through the positive electrode relay 35 and the negative electrode relay 36 is smaller than that in the above-described example (the long-dash double-short-dash line Q1 in FIG. 1), in which a relay is switched in a situation in which the charged voltage VC1 of the first capacitor 41 is lower than the output voltage VB of the first battery 22. This reduces the risk of fusing of the positive electrode relay 35 and the negative electrode relay 36 when the positive electrode relay 35 and the negative electrode relay 36 are switched on.

(3) The power needed to drive the load 18 varies significantly depending on the load 18. Accordingly, the amount of increase of voltage by the buck-boost converter 80 varies significantly in correspondence with the load 18, which is connected to the power supply circuit 16. The second capacitor 61 is required to have a capacitance capable of storing the power the voltage of which has been increased by the buck-boost converter 80. Therefore, different types of the second capacitor 61 that vary significantly in the capacitance are employed for different types of the load 18, which is connected to the power supply circuit 16.

In contrast, the first capacitor 41, which is connected to a section closer to the first battery 22 than the buck-boost converter 80, simply needs to have a capacitance capable of storing power output by the first battery 22. The power output by the first battery 22 is significantly smaller than the power required to drive the load 18. Accordingly, the capacitance required for the first capacitor 41 is significantly smaller than the capacitance required for the second capacitor 61. Due to such differences in the scale of capacitance, the capacitance of the first capacitor 41 is likely to vary less than the second capacitor 61 depending on each of the products employed in the power supply circuit 16. In general, batteries that have substantially the same rated voltage are employed as the first battery 22 regardless of the load 18, which is connected to the power supply circuit 16. Accordingly, capacitors that have substantially the same capacitance are employed as the first capacitor 41 regardless of the load 18, which is connected to the power supply circuit 16.

When the first capacitor 41 and the second capacitor 61 are discharged after the voltage increasing operation of the bidirectional converter 50 is stopped, the amounts of decrease in the charged voltages per unit time (hereinafter, referred to as a rate of decrease of charged voltage) differ depending on the capacitances of the capacitors 41, 61. Therefore, in the case of the second capacitor 61, for which different types of capacitors varying in the capacitance for each load 18 connected to the power supply circuit 16 are employed, the rate of decrease of the charged voltage VC2 after the voltage increasing operation is stopped varies significantly depending on the load 18. On the other hand, in the case of the first capacitor 41, for which capacitors having the same capacitance regardless of the load 18 connected to the power supply circuit 16 are employed, the rate of decrease of the charged voltage VC1 after the voltage increasing operation by the bidirectional converter 50 is stopped is substantially the same regardless of the load 18.

Therefore, in the above-described configuration, the pre-charge controlling unit 104 uses the charged voltage VC1 of the first capacitor 41, out of the charged voltage VC1 of the first capacitor 41 and the charged voltage VC2 of the second capacitor 61, to determine the point in time at which the positive electrode relay 35 and the negative electrode relay 36 are switched. By using the charged voltage VC1 of the first capacitor 41 to determine the point in time at which the positive electrode relay 35 and the negative electrode relay 36 are switched, the point in time of switching of the positive electrode relay 35 and the negative electrode relay 36 is set uniformly regardless of the load 18 to be connected. This is favorable in carrying out various types of control in a consistent manner before and after switching of the positive electrode relay 35 and the negative electrode relay 36, regardless of the load 18 to be connected.

The present embodiment may be modified as follows. The present embodiment and the following modifications can be combined as long as the combined modifications remain technically consistent with each other.

The voltage difference limit VPM, which specifies the permissible voltage difference VP, may be any limit value of a voltage difference that does not allow a flow of current large enough to cause a failure, which is not limited to fusing, in the operation of the positive electrode relay 35 and the negative electrode relay 36 when the relays 35, 36 are turned on.

The method of calculating the target voltage range VZ is not limited to the example of the above-described embodiment. The lower limit of the target voltage range VZ may be calculated as a value acquired by subtracting the permissible voltage difference VP from the output voltage VB of the first battery 22, for example. Also, the upper limit of the target voltage range VZ may be calculated as the output voltage VB of the first battery 22.

The lower limit of the target voltage range VZ may be calculated as a value acquired by subtracting the permissible voltage difference VP from the output voltage VB of the first battery 22, and the upper limit of the target voltage range VZ may be calculated as a value acquired by adding the permissible voltage difference VP to the output voltage VB of the first battery 22. In this case, the permissible voltage difference VP used to calculate the lower limit of the target voltage range VZ may be different from the permissible voltage difference VP used to calculate the upper limit. Any value can be used as the permissible voltage difference VP as long as it is less than or equal to the voltage difference limit VPM.

The permissible voltage difference VP may be zero. In this case, the target voltage range VZ does not have a width, but is a specific value.

The point in time at which the positive electrode relay 35 and the negative electrode relay 36 are switched on is not limited to that in the example of the above-described embodiment. The positive electrode relay 35 and the negative electrode relay 36 may be switched on when the charged voltage VC1 of the first capacitor 41 is lower than or equal to the output voltage VB of the first battery 22 during the pre-charge process. The point in time at which the positive electrode relay 35 and the negative electrode relay 36 are switched on may be changed in addition to changing the upper limit and the lower limit of the target voltage range VZ as in the above-described modification. The positive electrode relay 35 and the negative electrode relay 36 are prevented from fusing if the positive electrode relay 35 and the negative electrode relay 36 can be switched on when the charged voltage VC1 of the first capacitor 41 is a value within the target voltage range VZ.

The point in time at which the positive electrode relay 35 and the negative electrode relay 36 are switched may be determined by using the charged voltage VC2 of the second capacitor 61. The use of the charged voltage VC2 of the second capacitor 61 presents no drawbacks if the contents of various control processes are configured so as to allow for variations in the rate of decrease of the charged voltage VC2 among products.

The converter controlling signal is not limited to the stop signal PN in the above-described embodiment. The converter controlling signal may be any signal as long as it is related to the converter output voltage VD. The converter controlling signal may also be any signal as long as the voltage increasing unit 204 can stop the voltage increasing operation of the bidirectional converter 50 based on that converter controlling signal.

The converter controlling signal may be, for example, a signal that indicates the value of the charged voltage VC1 of the first capacitor 41 (hereinafter, simply referred to as the charged voltage VC1 of the first capacitor 41). In this case, the converter controlling signal, that is, the charged voltage VC1 of the first capacitor 41, is a signal that indicates the same value as the converter output voltage VD. If the charged voltage VC1 of the first capacitor 41 is used as the converter controlling signal, the completion of voltage increase by the bidirectional converter 50 can be determined using the charged voltage VC1 of the first capacitor 41 in the voltage increasing unit 204.

Specifically, when the voltage increasing unit 204 starts the voltage increasing operation of the bidirectional converter 50, the pre-charge controlling unit 104 repeatedly outputs, as the converter controlling signal, the latest charged voltage VC1 of the first capacitor 41 to the voltage increasing unit 204. The voltage increasing unit 204 then repeatedly compares the received charged voltage VC1 of the first capacitor 41 with the output voltage VB of the first battery 22, which is the lower limit VZ1 of the target voltage range VZ. When the charged voltage VC1 of the first capacitor 41 reaches the output voltage VB of the first battery 22, the voltage increasing unit 204 determines that the voltage increase by the bidirectional converter 50 is completed, and stops the voltage increasing operation of the bidirectional converter 50. The voltage increasing unit 204 outputs, to the pre-charge controlling unit 104, a signal indicating the completion of the voltage increase by the bidirectional converter 50. Thereafter, as in the case of the pre-charge control process for occurrence of failure in the above-described embodiment, the pre-charge controlling unit 104 switches on the positive electrode relay 35 and the negative electrode relay 36 when the charged voltage VC1 of the first capacitor 41 is switched from an increasing state to a decreasing state and becomes a value within the target voltage range VZ. In a case in which such a configuration is employed, the voltage increasing unit 204 stops the voltage increasing operation of the bidirectional converter 50 based on the charged voltage VC1 of the first capacitor 41, which is used as the converter controlling signal.

If the charged voltage VC1 of the first capacitor 41 is used as the converter controlling signal, there is a time lag due to, for example, the transfer of the charged voltage VC1 between the pre-charge controlling unit 104 and the voltage increasing unit 204. Accordingly, the charged voltage VC1 acquired by the voltage increasing unit 204 is not a real-time charged voltage VC1, but is a charged voltage VC1 of the time prior to the present by the amount corresponding to the time lag. Thus, the point in time at which the voltage increasing unit 204 determines that the voltage increase is completed is delayed with respect to the point in time at which the real-time charged voltage VC1 reaches the output voltage VB of the first battery 22. Therefore, even when the charged voltage VC1 of the first capacitor 41 is used as the converter controlling signal, the positive electrode relay 35 and the negative electrode relay 36 are prevented from fusing by switching on the positive electrode relay 35 and the negative electrode relay 36 when, after the voltage increasing operation of the bidirectional converter 50 is stopped, the charged voltage VC1 of the first capacitor 41 shifts from an increase to a decrease so as to be a value within the target voltage range VZ.

The configuration of the power supply circuit 16 is not limited to the example of the above-described embodiment. For example, a temperature sensor may be provided to monitor the state of the first battery 22.

The configuration of the load 18 is not limited to the example of the above-described embodiment. For example, the number of the motor generator 14 may be changed.

The vehicle 10 may be an electric vehicle, which is not provided with the internal combustion engine 12.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller configured to control a power supply circuit, wherein
the power supply circuit includes
a first battery,
a battery voltage sensor configured to detect an output voltage of the first battery,
a relay that selectively establishes and breaks an electrical connection from the first battery to a load,
a second battery having a rated voltage lower than a rated voltage of the first battery,
a converter configured to increase an output voltage of the second battery and to output the increased output voltage to a section between the relay and the load,
a converter voltage sensor configured to detect an output voltage of the converter,
a capacitor that is located between the relay and the load and is connected to the relay, and
a capacitor voltage sensor configured to detect a charged voltage of the capacitor,
the controller is configured to execute a pre-charge process that performs, in a state in which the electrical connection between the first battery and the load is broken by the relay, a voltage increasing operation of the converter until the output voltage of the converter becomes a value within a target voltage range, which is set based on the output voltage of the first battery,
the controller comprising:
a voltage increasing unit configured to acquire the output voltage of the converter and to perform the voltage increasing operation of the converter until the output voltage of the converter becomes a value within the target voltage range; and
a pre-charge controlling unit configured to acquire the output voltage of the first battery and the charged voltage of the capacitor, to cause the voltage increasing unit to perform the voltage increasing operation of the converter, and to control switching of the relay, wherein
the pre-charge controlling unit is configured to output a converter controlling signal, which is related to the output voltage of the converter, to the voltage increasing unit in a case in which the voltage increasing unit is caused to perform the voltage increasing operation of the converter under a situation in which an acquisition failure has occurred in which the voltage increasing unit is unable to acquire the output voltage of the converter,
the voltage increasing unit is configured to stop the voltage increasing operation of the converter based on the converter controlling signal delivered from the pre-charge controlling unit, and
the pre-charge controlling unit is configured to, after the charged voltage of the capacitor shifts from an increase to a decrease in response to stopping of the voltage increasing operation of the converter
refrain from switching the relay when the charged voltage of the capacitor is out of the target voltage range, and
establish the electrical connection of the relay when the charged voltage of the capacitor becomes a value within the target voltage range.

2. The controller for a power supply circuit according to claim 1, wherein the pre-charge controlling unit is configured to output, as the converter controlling signal, a stop signal that stops the voltage increasing operation of the converter to the voltage increasing unit when the charged voltage of the capacitor reaches the output voltage of the first battery.

3. The controller for a power supply circuit according to claim 2, wherein
the capacitor is a first capacitor,
the converter is a first converter,
the controller further comprises:
a second capacitor that is located between the first capacitor and the load and is connected in parallel with the first capacitor; and
a second converter that is connected across the first capacitor and the second capacitor, the second converter being configured to increase the output voltage of the first battery and to output the increased output voltage to the load,
the second converter includes a diode that is configured to allow for flow of current from the first capacitor to the second capacitor, while prohibiting flow of current from the second capacitor to the first capacitor, and
the pre-charge controlling unit is configured to establish, after outputting the stop signal to the voltage increasing unit, the electrical connection of the relay when a charged voltage of the first capacitor or a charged voltage of the second capacitor is a value higher than the output voltage of the first battery.

4. The controller for a power supply circuit according to claim 3, wherein the pre-charge controlling unit is configured to establish the electrical connection of the relay when the charged voltage of the first capacitor, which is one of the charged voltage of the first capacitor and the charged voltage of the second capacitor, is a value higher than the output voltage of the first battery.

5. A non-transitory computer readable storage medium that stores a program that causes a controller to execute a process that controls a power supply circuit, wherein
the power supply circuit includes
a first battery,
a battery voltage sensor configured to detect an output voltage of the first battery,
a relay configured to selectively establish and break an electrical connection from the first battery to a load,
a second battery having a rated voltage lower than a rated voltage of the first battery,
a converter configured to increase an output voltage of the second battery and to output the increased output voltage to a section between the relay and the load,
a converter voltage sensor configured to detect an output voltage of the converter,
a capacitor that is located between the relay and the load and is connected to the relay, and
a capacitor voltage sensor configured to detect a charged voltage of the capacitor,
the process comprising:
a pre-charge process that performs, in a state in which the electrical connection between the first battery and the load is broken by the relay, a voltage increasing operation of the converter until the output voltage of the converter becomes a value within a target voltage range, which is set based on the output voltage of the first battery;
a voltage increasing operation process that acquires the output voltage of the converter and performs the voltage increasing operation of the converter until the output voltage of the converter becomes a value within the target voltage range; and
a pre-charge control process that acquires the output voltage of the first battery and the charged voltage of the capacitor, causes the voltage increasing operation process to perform the voltage increasing operation of the converter, and controls switching of the relay, wherein
the pre-charge control process includes a process that outputs a converter controlling signal, which is related to the output voltage of the converter, in a case in which the voltage increasing operation process is caused to perform the voltage increasing operation of the converter under a situation in which an acquisition failure has occurred in which the output voltage of the converter cannot be acquired in the voltage increasing operation process,
the voltage increasing operation process includes a process that stops the voltage increasing operation of the converter based on the converter controlling signal delivered in the pre-charge control process, and
the pre-charge control process includes a process that, after the charged voltage of the capacitor shifts from an increase to a decrease in response to stopping of the voltage increasing operation of the converter
refrains from switching the relay when the charged voltage of the capacitor is out of the target voltage range, and
establishes the electrical connection of the relay when the charged voltage of the capacitor becomes a value within the target voltage range.

6. A method for controlling a power supply circuit, wherein
the power supply circuit includes
a first battery,
a battery voltage sensor configured to detect an output voltage of the first battery,
a relay configured to selectively establish and break an electrical connection from the first battery to a load,
a second battery having a rated voltage lower than a rated voltage of the first battery,
a converter that increases an output voltage of the second battery and outputs the increased output voltage to a section between the relay and the load,
a converter voltage sensor configured to detect an output voltage of the converter,
a capacitor that is located between the relay and the load and is connected to the relay, and
a capacitor voltage sensor configured to detect a charged voltage of the capacitor,
the method comprising:
executing a pre-charge process that performs, in a state in which the electrical connection between the first battery and the load is broken by the relay, a voltage increasing operation of the converter until the output voltage of the converter becomes a value within a target voltage range, which is set based on the output voltage of the first battery,
executing a voltage increasing operation process that acquires the output voltage of the converter and performs the voltage increasing operation of the converter until the output voltage of the converter becomes a value within the target voltage range, and
executing a pre-charge control process that acquires the output voltage of the first battery and the charged voltage of the capacitor, causes the voltage increasing operation process to perform the voltage increasing operation of the converter, and controls switching of the relay, wherein
the pre-charge control process includes outputting a converter controlling signal, which is related to the output voltage of the converter, in a case in which the voltage increasing operation process is caused to perform the voltage increasing operation of the converter under a situation in which an acquisition failure has occurred in which the output voltage of the converter cannot be acquired in the voltage increasing operation process,
the voltage increasing operation process includes stopping the voltage increasing operation of the converter based on the converter controlling signal delivered in the pre-charge control process, and
after the charged voltage of the capacitor shifts from an increase to a decrease in response to stopping of the voltage increasing operation of the converter, the pre-charge control process
refrains from switching the relay when the charged voltage of the capacitor is out of the target voltage range, and
establishes the electrical connection of the relay when the charged voltage of the capacitor becomes a value within the target voltage range.
